(19) United States
(12) Patent Application Publication
(10) Pub. No.: US 2003/0140026 A1
(43) Pub. Date: Jul. 24, 2003

(54) System and method for evaluating actions under international law

(76) Inventor: Thomas C. Wingfield, Morningside, MD (US)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 09/989,694

(22) Filed: Nov. 21, 2001

(51) Int. Cl. G06F 17/00; G06N 5/02; G06F 17/60

(52) U.S. Cl. 706/933; 706/46; 705/1

(57) ABSTRACT

A system and method for determining whether an action is a use of fore or an armed attack under international law comprising determining the action's Severity, Immediacy, Directness, Invasiveness, Measurability, Presumptive Legitimacy, and Responsibility. Individual legal weights may also be assigned to the Severity magnitude, the Immediacy magnitude, the Directness magnitude, the Invasiveness magnitude, the Measurability magnitude, the Presumptive Legitimacy magnitude, and the Responsibility magnitude in order to calculate a composite value quantifying the consequences of the action.

### FIELD OF THE INVENTION

The present invention relates to the field of international law. More particularly, the present invention relates to a system and method for determining whether an action is a use of force or an armed attack under international law.

### BACKGROUND

For the purposes of analyzing what constitutes a “use of force” or an “armed attack” under international law, there are three relevant categories. First, the peacetime regime of international law, jus in pace, governs the conduct of states at peace, and it remains in place during armed conflict to the extent it is not inconsistent with hostilities. Second, the law of conflict management, jus ad bellum, governs the resort to the use of force between states. Third, the law of armed conflict, jus in bello, governs the actual conduct of hostilities.

Armed conflict in the new battlefield of cyberspace raises two principle questions: 1) what actions in cyberspace constitute a “use of force” or “armed attack” under international law, and 2) how does the traditional law of armed conflict apply to information operations which exceed this threshold?

The law of conflict management, jus ad bellum, authoritatively addresses the first question. Article 2(4) of the Charter of the United Nations, the entity of which is incorporated herein by reference, requires all Member States to “refrain in their international relations from the threat or use of force against the territorial integrity or political independence of any state . . . ” The United Nations Charter clearly outlaws the aggressive use of force while recognizing a state's inherent right of individual and collective self-defense in Article 51 and the Security Council's obligation under Article 39 to maintain or restore international peace and security. Articles 2(4), 39, and 51 of the Charter now codify the contemporary jus ad bellum in its entirety. If a state activity is a use of force within the meaning of Article 2(4), it is unlawful unless it is an exercise of that state's inherent right of self-defense under Article 51, or unless it is authorized by the Security Council under Article 39.

There is no mechanical rule in the law of conflict management that clearly defines what a use of force is under all circumstances. Generally, a state activity that threatens the territorial integrity or political independence of another state constitutes an unlawful “use of force” within the meaning of Article 2(4) of the Charter of the United Nations. What constitutes a prohibited “threat or use of force” is a question of fact that must be subjectively analyzed in each case in the context of all relevant law and circumstances.

A comprehensive discussion of historical and current international law governing a use of force or an armed attack is contained in Thomas C. Wingfield, Law of Information Conflict (2000), the entirety of which is incorporated herein by reference.

In Bellum Americanum: The US View of Twenty-First Century War and Its Possible Implications for the Law of Armed Conflict, 19 Mich. J. Int'l L. 1051, 1071-72 (1998), the entirety of which is incorporated herein by reference, Professor Michael N. Schmitt, then of the US Naval War College's Department of Oceans Law and Policy, wrote:

In the current normative scheme the consequences of an act are often less important than its nature. For instance, a devastating economic embargo is not a “use of force” nor an “armed attack” justifying forcible self-defense, even though the embargo may result in enormous suffering. On the other hand, a relatively minor, armed incursion across a border is both a use of force and an armed attack. This contrary result derives from the law's use of “acts” as a cognitive shorthand for what really matters—consequences. Acts are more easily expressed (to “use force” versus to cause a certain quantum and quality of harm) and more easily discerned than an effects-based standard, on the harm suffered. This cognitive shorthand does not work well in the age of information operations because information attacks, albeit potentially disastrous, may be physically imperceptible. Thus, as the nature of a hostile act becomes less determinative of its consequences, current notions of “lawful” coercive behavior by states, and the appropriate response thereto, are likely to evolve accordingly.

Central to Schmitt's analysis is that the consequences of a computer network attack, or any information operation, have two principal characteristics: a quantitative aspect, which describes the quantum of damage, or real-world consequences, of an operation, and a less-often acknowledged qualitative aspect, which describes the nature of the instrument used to product the effect. This two-prong test would establish a much lower level of permissible damage done (the consequence) for military force than for economic or diplomatic force (the instrument). For this reason, the qualitative characterization of an information operation can matter as much as the quantitative level of harm inflicted. The intellectual challenge, then, is to evaluate the quantitative consequences of a proposed information operation in terms of the qualitative criteria that distinguishes military force from diplomatic or economic coercion. By analyzing an information operation in this manner, two goals will be satisfied: first, its real-world destructive consequences would form the basis of the decision of whether or not to carry it out, and second, these consequences would be expressed in such a way as to bring the analysis in line with the UN Charter drafters' principled distinction between military and other forms of coercion.

In Computer Network Attack and the Use of Force in International Law: Thoughts on a Normative Framework, 37 Colum. J. Transnat'l L. 887, 914-15 (1999), the entirety of which is incorporated herein by reference, Prof. Schmitt suggests using seven criteria for evaluating actions under international law:

1. Severity: Armed attacks threaten physical injury or destruction of property to a much greater extent than other forms of coercion. Physical well being usually occupies the lowest, most basic level in the human hierarchy of need.

2. Immediacy: The negative consequences of armed coercion, or threat thereof, usually occur with greater immediacy, while those of other forms of coercion develop more slowly. Thus, the opportunity for the target state or the international community to seek peaceful accommodation is hampered in the former case.

3. Directness: The consequences of armed coercion are more directly tied to the actus reus than in other forms of coercion, which often depend on numerous contributory factors to operate. Thus the prohibition on force precludes negative consequences with greater certainty.

4. Invasiveness: In armed coercion, the act causing the harm usually crosses into the target state, whereas in economic warfare the acts generally occur beyond the target's borders. As a result, even though armed and economic acts may have roughly similar consequences, the former represents a greater intrusion on the rights of the target state and, therefore, is more likely to disrupt international stability.

5. Measurability: While the consequences of armed coercion are usually easy to ascertain (e.g., a certain level of destruction), the actual negative consequences of other forms of coercion are harder to measure. This fact renders the appropriateness of community condemnation, and the degree of vehemence contained therein, less suspect in the case of armed force.

6. Presumptive Legitimacy: In most cases, whether under domestic or international law, the application of violence is deemed illegitimate absent some specific exception such as self-defense. The cognitive approach is prohibitory. By contrast, most other forms of coercion—again in the domestic and international sphere—are presumptively lawful, absent a prohibition to the contrary. The cognitive approach is permissive. Thus, the consequences of armed coercion are presumptively impermissible, whereas those of other coercive acts are not (as a very generalized rule).

7. Responsibility: Armed coercion is the exclusive province of states; only they may generally engage in uses of force across borders, and in most cases, only they have the ability to do so with any meaningful impact. By contrast, non-governmental entities are often capable of engaging in other forms of coercion (propaganda, boycotts, etc.). Therefore, with armed coercion the likelihood of blurring the relative responsibility of the state, a traditional object of international prescription, and private entities, usually only the object of international administration, narrows. The consequences of armed coercion are more susceptible to being charged to a state actor than in the case of other forms of coercion.

These factors are the lens through which international actions may be analyzed to determine both the quantum of their real-world destructiveness and the qualitative conformance with existing Charter standards of permissible and impermissible coercion.

However, until the introduction of the present invention, there was no means for structured quantitative analyses of actions under international law. The Charter of the United Nations provides a qualitative framework, but there is a need for a means for quantitatively analyzing actions to determine whether they are uses of force or armed attacks under international law.

### SUMMARY OF THE INVENTION

The present invention is directed to a method and system for evaluating actions under international law. In one aspect of the invention, a method is provided for evaluating actions under international law, comprising the steps of identifying an action and the action's effects and performing a Primary Schmitt Analysis.

In another aspect of the invention, a method is provided for evaluating actions under international law, comprising the steps of identifying an action and the action's effects, performing a Primary Schmitt Analysis, and performing a Secondary Schmitt Analysis.

In another aspect of the invention, a method is provided for performing a Primary Schmitt analysis comprising determining an action's Severity, determining the action's Immediacy, determining the action's Directness, determining the action's Invasiveness, determining the action's Measurability, determining the action's Presumptive Legitimacy, and determining Responsibility for the action.

In a further aspect of the invention, a method is provided for performing a Primary Schmitt analysis comprising assigning a numerical Severity magnitude in response to determining an action's Severity, assigning a numerical Immediacy magnitude in response to determining the action's Immediacy, assigning a numerical Directness magnitude in response to determining the action's Directness, assigning a numerical Invasiveness magnitude in response to determining the action's Invasiveness, assigning a numerical Measurability magnitude in response to determining the action's Measurability, assigning a numerical Presumptive Legitimacy magnitude in response to determining the action's Presumptive Legitimacy, and assigning a numerical Responsibility magnitude in response to determining Responsibility for the action.

In still another aspect of the invention, a method is provided for performing a Primary Schmitt analysis comprising calculating an arithmetic average of the Severity magnitude, the Immediacy magnitude, the Directness magnitude, the Invasiveness magnitude, the Measurability magnitude, the Presumptive Legitimacy magnitude, and the Responsibility magnitude. In a further aspect of the invention, the arithmetic average is used to determine whether the action is a use of force according to United Nations Charter Article 2(4).

In yet another aspect of the invention, a method is provided for performing a Primary Schmitt analysis comprising displaying the arithmetic average, the Severity magnitude, the Immediacy magnitude, the Directness magnitude, the Invasiveness magnitude, the Measurability magnitude, the Presumptive Legitimacy magnitude, and the Responsibility magnitude.

In another aspect of the invention, a method is provided for performing a Secondary Schmitt analysis comprising assigning a legal weight to the Severity magnitude, the Immediacy magnitude, the Directness magnitude, the Invasiveness magnitude, the Measurability magnitude, the Presumptive Legitimacy magnitude, and the Responsibility magnitude. In a further aspect of the invention, the Severity magnitude is multiplied by its legal weight to produce a Severity result, the Immediacy magnitude is multiplied by its legal weight to produce an Immediacy result, the Directness magnitude is multiplied by its legal weight to produce a Directness result, the Invasiveness magnitude is multiplied by its legal weight to produce an Invasiveness result, the Measurability magnitude is multiplied by its legal weight to produce a Measurability result, the Presumptive Legitimacy magnitude is multiplied by its legal weight to produce a Presumptive Legitimacy result, and the Responsibility magnitude is multiplied by its legal weight to produce a Responsibility result.

In a further aspect of the invention, a method is provided for performing a Secondary Schmitt analysis comprising adding the Severity result, the Immediacy result, the Directness result, the Invasiveness result, the Measurability result, the Presumptive Legitimacy result, and the Responsibility result to produce an aggregate sum, and dividing the aggregate sum by a sum of the legal weight of the Severity magnitude, the legal weight of the Immediacy magnitude, the legal weight of the Directness magnitude, the legal weight of the Invasiveness magnitude, the legal weight of the Measurability magnitude, the legal weight of the Presumptive Legitimacy magnitude, the legal weight of the Responsibility magnitude to calculate a weighted magnitude. In a further aspect of the invention, the weighted magnitude is used to determine whether the action is a use of force according to United Nations Charter Article 2(4).

In another aspect of the invention, a computer program product is provided comprising a computer usable medium having computer program logic recorded thereon for enabling a processor in a computer system to facilitate performing Primary and Secondary Schmitt analyses. The computer program logic comprises storage means for enabling the processor to store a Severity magnitude, an Immediacy magnitude, a Directness magnitude, an Invasiveness magnitude, a Measurability magnitude, a Presumptive Legitimacy magnitude, a Responsibility magnitude, and each of their legal weights. The computer program logic also comprises calculating means for calculating an arithmetic average of the Severity magnitude, the Immediacy magnitude, the Directness magnitude, the Invasiveness magnitude, the Measurability magnitude, the Presumptive Legitimacy magnitude, and the Responsibility magnitude. The calculating means may also calculate a product of the Severity magnitude and its legal weight to produce a Severity result, a product of the Immediacy magnitude and its legal weight to produce an Immediacy result, a product of the Directness magnitude and its legal weight to produce a Directness result, a product of the Invasiveness magnitude and its legal weight to produce an Invasiveness result, a product of the Measurability magnitude and its legal weight to produce a Measurability result, a product of the Presumptive Legitimacy magnitude and its legal weight to produce a Presumptive Legitimacy result, a product of the Responsibility magnitude and its legal weight to produce a Responsibility result, a sum of the Severity result, the Immediacy result, the Directness result, the Invasiveness result, the Measurability result, the Presumptive Legitimacy result, and the Responsibility result to produce an aggregate sum, and a quotient of the aggregate sum divided by a sum of the legal weight of the Severity magnitude, the legal weight of the Immediacy magnitude, the legal weight of the Directness magnitude, the legal weight of the Invasiveness magnitude, the legal weight of the Measurability magnitude, the legal weight of the Presumptive Legitimacy magnitude, the legal weight of the Responsibility magnitude to produce a weighted magnitude.

In another aspect of the invention, an analysis system is provided comprising a data processing apparatus and input means for inputting instructions to the data processing apparatus in order to perform a Schmitt analysis responsive to a selected Severity magnitude and its selected legal weight, a selected Immediacy magnitude and its selected legal weight, a selected Directness magnitude and its selected legal weight, a selected Invasiveness magnitude and its selected legal weight, a selected Measurability magnitude and its selected legal weight, a selected Presumptive Legitimacy magnitude and its selected legal weight, and a selected Responsibility magnitude and its selected legal weight. In a further aspect of the invention, the analysis system further comprises means for storing and retrieving the selected Severity magnitude and its selected legal weight, the selected Immediacy magnitude and its selected legal weight, the selected Directness magnitude and its selected legal weight, the selected Invasiveness magnitude and its selected legal weight, the selected Measurability magnitude and its selected legal weight, the selected Presumptive Legitimacy magnitude and its selected legal weight, and the selected Responsibility magnitude and its selected legal weight.

The present invention advantageously provides a tool for quantitatively evaluating international actions and their resulting effects.

It is an advantage of the present invention to provide criteria under which international actions can be evaluated to determine legality under Article 2(4) of the U.N. Charter.

It is another advantage of the invention to provide a common structural framework to analyze international actions in order to yield analytically comparable results across multiple fact patterns.

It is still another advantage of the invention to yield an analytically complete analysis which can be incorporated into legal briefs or briefings to decision makers.

These and other features and advantages of the invention will be more fully understood from the following detailed description of a preferred embodiment that should be read in light of the accompanying drawings.

### BRIEF DESCRIPTION 0F THE DRAWINGS

The accompanying drawings, which are incorporated in and form a part of the specification, illustrate a preferred embodiment of the present invention and, together with the description, serve to explain the principles of the invention.

FIG. 1 illustrates an embodiment of the present invention;

FIG. 2 illustrates an embodiment of the present invention;

FIG. 3 illustrates an embodiment of the present invention;

FIG. 4 illustrates an embodiment of the present invention;

FIG. 5 illustrates an embodiment of the present invention;

FIG. 6 illustrates an embodiment of the present invention;

FIG. 7 illustrates an embodiment of the present invention;

FIG. 8 illustrates an embodiment of the present invention;

FIG. 9 illustrates an embodiment of the present invention;

FIG. 10 illustrates an embodiment of the present invention;

FIG. 11 illustrates an embodiment of the present invention;

FIG. 12 illustrates an embodiment of the present invention;

FIG. 13 illustrates an embodiment of the present invention; and

FIG. 14 illustrates one embodiment of a computer system suitable for use with the present invention.

### DETAILED DESCRIPTION

In describing preferred embodiments of the invention, specific terminology will be used for the sake of clarity. However, the invention is not intended to be limited to the specific terms so selected, and it is to be understood that each specific term includes all equivalents.

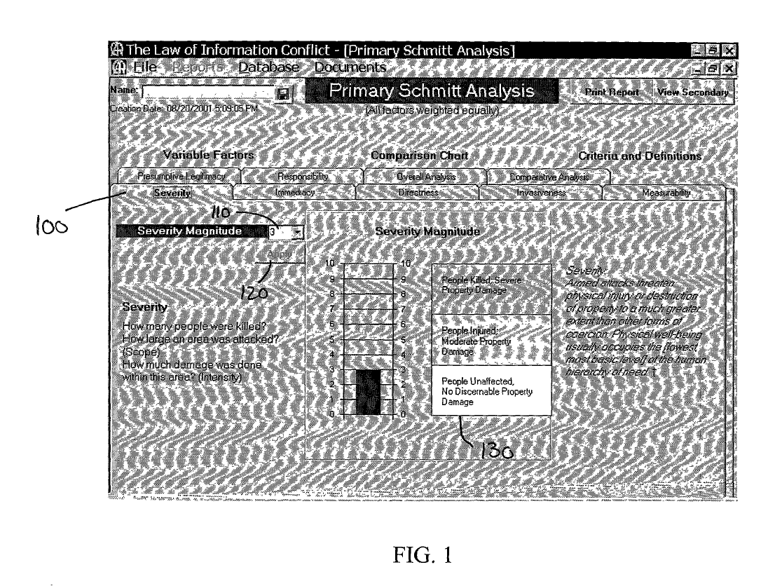

With reference to the drawings, in general, and FIGS. 1 through 14 in particular, the present invention is described.

The present invention allows a user to analyze various real and hypothetical fact patterns using Schmitt analysis factors. These analyses of the invention help determine whether a selected course of action is a use of force under international law. The results are influenced by the different opinions, beliefs, experiences, and biases of the individuals involved in the decision-making. The value of the invention is its ability to produce a quantitative assessment that can be compared to other assessments and to validate or challenge complex options with greater certainty.

In embodiments, the invention provides a principled intellectual framework for analyzing whether any given information operation rises to the level of a “use of force” or “armed attack” under international law. Specifically, in embodiments, the invention calculates the magnitude and weight of the seven factors (Severity, Immediacy, Directness, Invasiveness, Measurability, Presumptive Legitimacy, and Responsibility) that discriminate military actions from diplomatic and economic coercion. The invention is a decision support tool that can be used to measure new fact patterns using traditional laws of armed conflict. The invention assists an attorney and client in jointly evaluating proposed courses of action by highlighting alternative scenarios with 3-dimensional graphics and calibrating their relative lawfulness under the Charter of the United Nations for comparative analysis.

The following fictional scenario is an illustrative example of how an embodiment invention may be used. Suppose, for example, the U.S. government is currently at a diplomatic impasse with the country of People's Democratic Republic (PDR), a medium-sized country with aspirations for regional hegemony and a military capability that far exceeds its defense needs. PDR is a threat to its neighbors, who are U.S. allies in the region. U.S. national interest lies in the fact that those neighbors are the world's primary source of key raw materials essential to various American industries. PDR's dominance over the region could have strong negative effects on the U.S. and world economies. Furthermore, PDR has been threatening to invade a neighboring country, citing territorial claims that date back more than 150 years to a war that PDR lost.

The U.S. government has stated publicly that “all options are on the table” for dealing with the situation, and the State Department and the Department of Defense are exploring options. They have suggested the option of shutting down electrical power generation and distribution in PDR, which will be accomplished either before or at the onset of hostilities. The primary operational goals are to exert economic pressure on PDR and, in the event of hostilities, to severely disable the country's command and control infrastructure, limiting PDR's capability to initiate armed aggression or retaliate against U.S. and allied military action. The U.S. would prefer to accomplish the goal with as little violence and bloodshed as possible and without hampering the military should an armed confrontation become necessary. Four possible courses of action are being examined:

Blockade—an economic blockade of PDR, which depends on foreign technology for its power generation and distribution;

Computer Network Attack—an information operation using a computer network attack to disable the computers that control power generation and distribution;

Carbon Fibers—airborne delivery of carbon fibers to short out the power generation and distribution equipment, effectively disabling the system and requiring massive repairs to restore it; or

Bombing Attack—aerial bombing of the power generation and distribution centers, physically destroying them beyond repair so they would have to be rebuilt.

For the purpose of this illustration, the Computer Network Attack is selected as the course of action most likely to achieve the mission's goals. In fact, in a real-world situation, each option would probably be analyzed separately and compared with each other. This is one of many scenarios for which the invention can be used as an analysis tool.

The invention can analyze this hypothetical scenario using a Schmitt Analysis framework. For the purpose of this illustration, the scenario is first analyzed under the seven factors of the Primary Schmitt Analysis. FIG. 1 illustrates an embodiment of the present invention used for determining the Severity Magnitude. In order to determine the Severity Magnitude, the Primary Schmitt Analysis posed three factual questions:

How many people were killed?

How large an area was attacked?

How much damage was done within the area attacked?

The answers to these questions involve an individual determination on a case-by-case basis. In this scenario, the answers to these questions determine the scope and intensity of the Computer Network Attack.

Assume it is determined that no one will be directly killed by the action. Furthermore, the entire target country will be affected, but local generators will somewhat ameliorate the effects. Damage will be limited to computer systems with the remainder of the infrastructure left intact.

Each Schmitt factor is divided into three levels of intensity. These levels of intensity span the spectrum of actions within each factor; examples are provided for each level by Definitions 130, for example. The examples in the bottom areas will tend to drive the analysis below the Article 2(4) threshold; the examples in the top areas will tend to drive the analysis above the threshold. The mid-range examples may be characterize either way, and with closer evaluation, may drive the analysis in either direction. The cumulative level of intensity of each of the seven factors determines the overall level of forcefulness, which is either above or below the Article 2(4) threshold.

In one embodiment, the Severity magnitude ranges from zero to about 3 for people unaffected, no discernable property damage; from about 4 to about 6 for people injured, moderate property damage; and from about 7 to about 10 for people killed, severe property damage. Alternatively, the Severity magnitude of the three definitional ranges can be from zero to 3.33, from 3.34 to 6.66, and from 6.67 to 10, respectively. As would be apparent to one skilled in the art, other Severity magnitudes can be selected for each definitional range.

Given the “facts,” it is determined that, on a scale from 1 to 10, the Severity Magnitude should be quantified as a 3. In embodiments of the invention, the Severity Magnitude can be determined using a different scale. The value of 3 is calibrated to Definitions 130 and shows that people were unaffected by the Computer Network Attack and there was no discernable property damage.

In order to enter this quantification into the invention, Severity Tab 100 is selected. The Severity Magnitude chosen can then be inputted in Entry 110. In embodiments, the magnitude for each Schmitt factor can be inputted as a fraction or with decimal places, 3.5 for example. Apply button 120 is then selected to submit the entry.

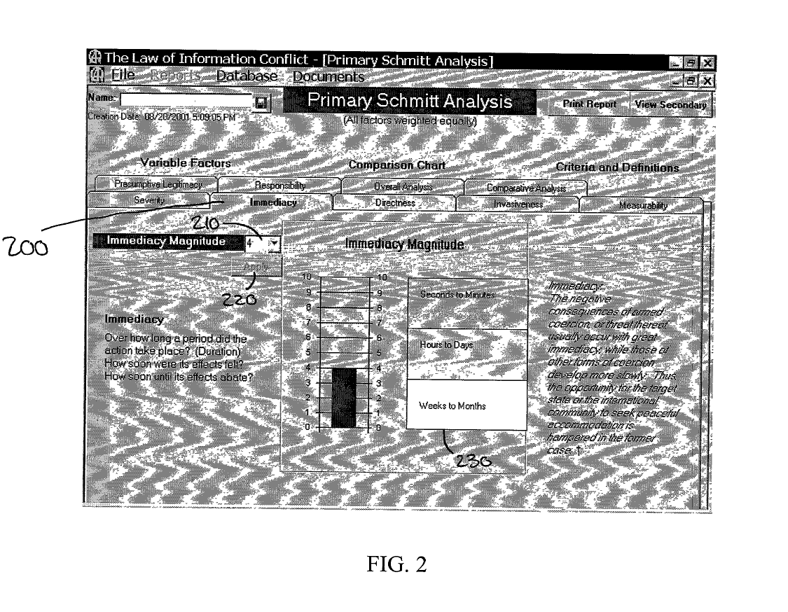

FIG. 2 illustrates an embodiment of the present invention used for determining the Immediacy Magnitude. In order to determine the Immediacy Magnitude, the Primary Schmitt Analysis poses three factual questions:

Over how long a period did the action take place?

How soon were the action's effects felt?

How soon until the action's effects abate?

In this scenario, the answers to these questions determine the immediacy of the Computer Network Attack.

In one embodiment, the Immediacy magnitude ranges from zero to about 3 for a period of weeks to months; from about 4 to about 6 for a period of hours to days; and from about 7 to about 10 for a period of seconds to minutes. Alternatively, the Immediacy magnitude of the three definitional ranges can be from zero to 3.33, from 3.34 to 6.66, and from 6.67 to 10, respectively. As would be apparent to one skilled in the art, other Immediacy magnitudes can be selected for each definitional range.

Assume it is determined that the effects will be immediate, but if the PDR has maintained its computers, the effects will abate as soon as the PDR is able to restore data and operational status of its networks and systems. As a result, it is determined that the Immediacy Magnitude should be quantified as a 4 on a scale of 1 to 10. The value of 4 for the Immediacy Magnitude is calibrated to Definitions 230 and shows that the effects of the Computer Network Attack will be felt and addressed in a matter of hours to days following the action.

In order to enter this quantification into the invention, Immediacy tab 200 is selected. The Immediacy Magnitude chosen can then be inputted into Entry 210. In embodiments, the magnitude for each Schmitt factor can be inputted as a fraction or with decimal places, 4.5 for example. Apply button 220 is then selected to submit the entry.

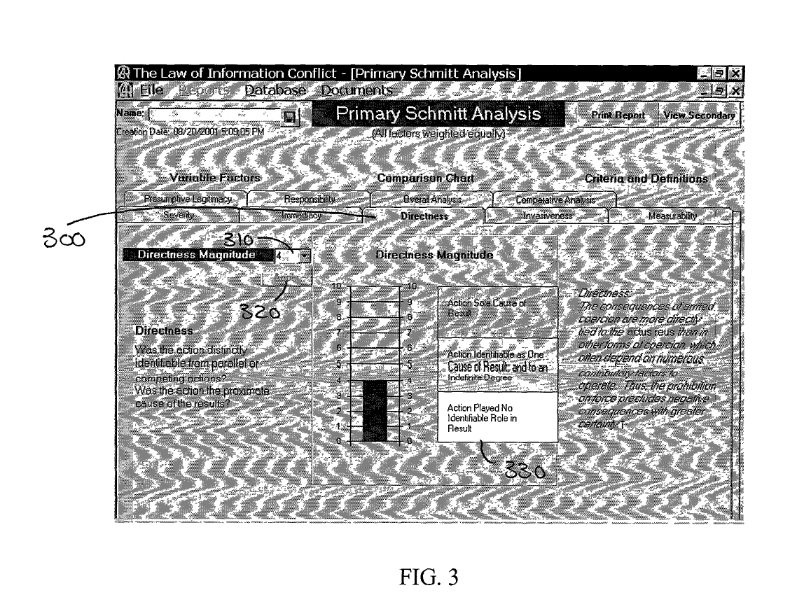

FIG. 3 illustrates an embodiment of the present invention used for determining the Directness Magnitude. In order to determine the Directness Magnitude, the Primary Schmitt Analysis poses two factual questions:

Was the action distinctly identifiable from parallel or competing actions?

Was the action the proximate cause of the effects?

In this scenario, the answers to these questions determine the directness of the Computer Network Attack.

A few years ago, a computer network attack would have been difficult to recognize in much of the world, but with the rapid dispersion of information technology, PDR would be likely to recognize an attack against one of its critical systems. As a result, it is determined that the Directness Magnitude should be quantified as a 4 on a scale of 1 to 10. The value 4 for the Directness Magnitude is calibrated to Definitions 330 and shows that the Computer Network Attack is identifiable as one cause of damage to an indefinite degree.

In one embodiment, the Directness magnitude ranges from zero to about 3 for an action played no identifiable role in result; from about 4 to about 6 for an action identifiable as one cause of result, and to an indefinite degree; and from about 7 to about 10 for an action sole cause of result. Alternatively, the Directness magnitude of the three definitional ranges can be from zero to 3.33, from 3.37 to 6.66, and from 6.67 to 10, respectively. As would be apparent to one skilled in the art, other Directness magnitudes can be selected for each definitional range.

In order to enter this quantification into the invention, Directness tab 300 is selected. The Directness Magnitude chosen can then be inputted into Entry 310. In embodiments, the magnitude for each Schmitt factor can be inputted as a fraction or with decimal places, 4.25 for example. Apply button 320 is then selected to submit the entry.

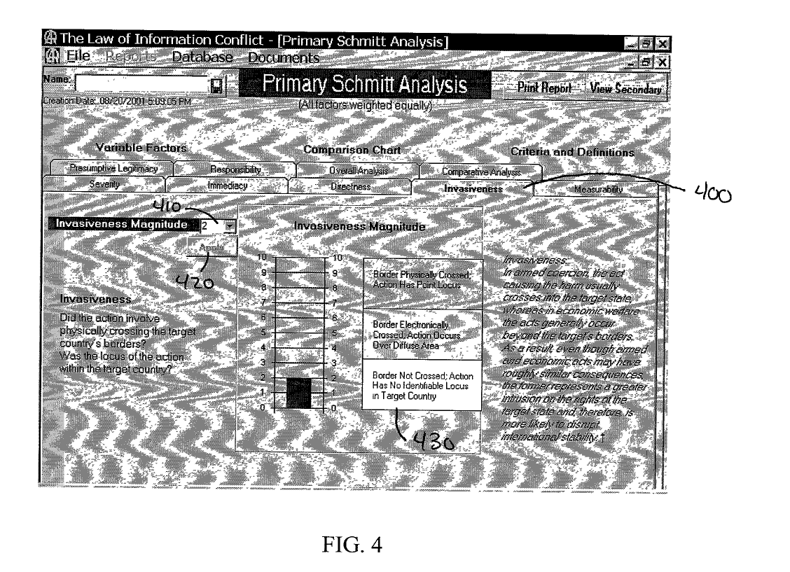

FIG. 4 illustrates an embodiment of the present invention used for determining the Invasiveness Magnitude. In order to determine the Invasiveness Magnitude, the Primary Schmitt Analysis poses two factual questions:

Did the action involve physically crossing the target country's borders?

Was the focus of the action within the target country?

In this scenario, the answers to these questions determine the invasiveness of the Computer Network Attack.

In one embodiment, the Invasiveness magnitude ranges from zero to about 3 for border not crossed, action has no identifiable locus in target country; from about 4 to about 6 for border electronically crossed, action occurs over diffuse area; and from about 7 to about 10 for border physically crossed, action has point locus. Alternatively, the Invasiveness magnitude of the three definitional ranges can be from zero to 3.33, from 3.34 to 6.66, and from 6.67 to 10, respectively. As would be apparent to one skilled in the art, other Invasiveness magnitudes can be selected for each definitional range.

Assume it is determined that the computer sending the messages that disable the networks is located outside the PDR, but the effects will be felt inside the PDR. As a result, it is determined that the Invasiveness Magnitude should be quantified as a 2 on a scale of 1 to 10. The value of 2 for the Invasiveness Magnitude is calibrated to Definitions 430 and shows that the Computer Network Attack has not crossed PDR's physical borders, and it has no identifiable locus within PDR's borders.

In order to enter this quantification into the invention, Invasiveness tab 400 is selected. The Invasiveness Magnitude chosen can then be inputted into Entry 410. In embodiments, the magnitude for each Schmitt factor can be inputted as a fraction or with decimal places, 2.5 for example. Apply button 420 is then selected to submit the entry.

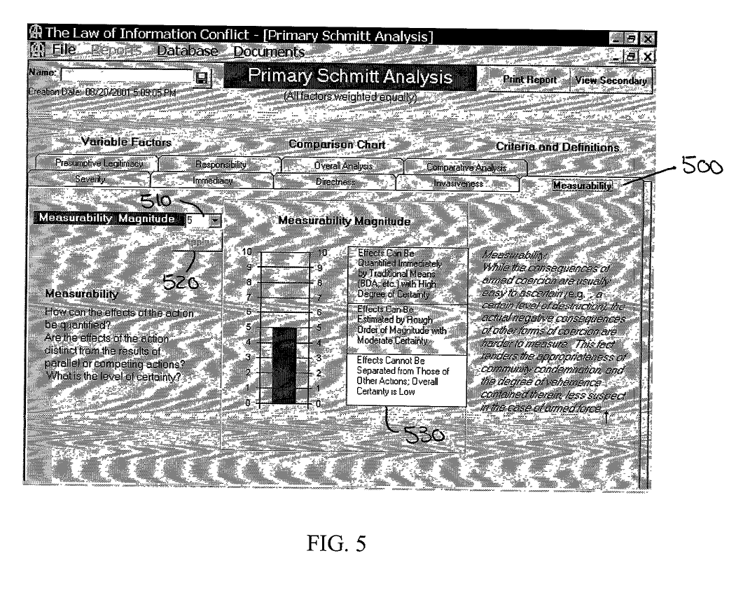

FIG. 5 illustrates an embodiment of the present invention used for determining the Measurability Magnitude. In order to determine the Measurability Magnitude, the Primary Schmitt Analysis poses three factual questions:

How can the effects of the action be quantified?

Are the effects of the action distinct from the results of parallel or competing actions?

What is the level of certainty?

In this scenario, the answers to these questions determine the measurability of the Computer Network Attack.

Since computers perform most measurements of contemporary economic activity, the PDR would notice the effects but would have difficulty measuring them. The Computer Network Attack would be very distinct from effects caused by other actions. Given the level of worldwide expertise in information technology, it is likely that PDR would know with near certainty the cause if its problems, even if the identity of the attacker remained hidden. As a result, it is determined that the Measurability Magnitude should be quantified as a 5 on a scale of 1 to 10. The value 5 for the Measurability Magnitude is calibrated to Definitions 530 and shows that the effects of the Computer Network Attack can be estimated by a rough order of magnitude and with moderate certainty.

In one embodiment, the Measurability magnitude ranges from zero to about 3 for effects cannot be separated from those of other actions, overall certainty is low; from about 4 to about 6 for effects can be estimated by rough order of magnitude with moderate certainty; and from about 7 to about 10 for effects can be quantified immediately by traditional means (BDA, etc.) with high degree of certainty. Alternatively, the Measurability magnitude of the three definitional ranges can be from zero to 3.33, from 3.34 to 6.66, and from 6.67 to 10, respectively. As would be apparent to one skilled in the art, other Measurability magnitudes can be selected for each definitional range.

In order to enter this quantification into the invention, Measurability tab 500 is selected. The Measurability Magnitude chosen can then be inputted into Entry 510. In embodiments, the magnitude for each Schmitt factor can be inputted as a fraction or with decimal places, 5.1 for example. Apply button 520 is then selected to submit the entry.

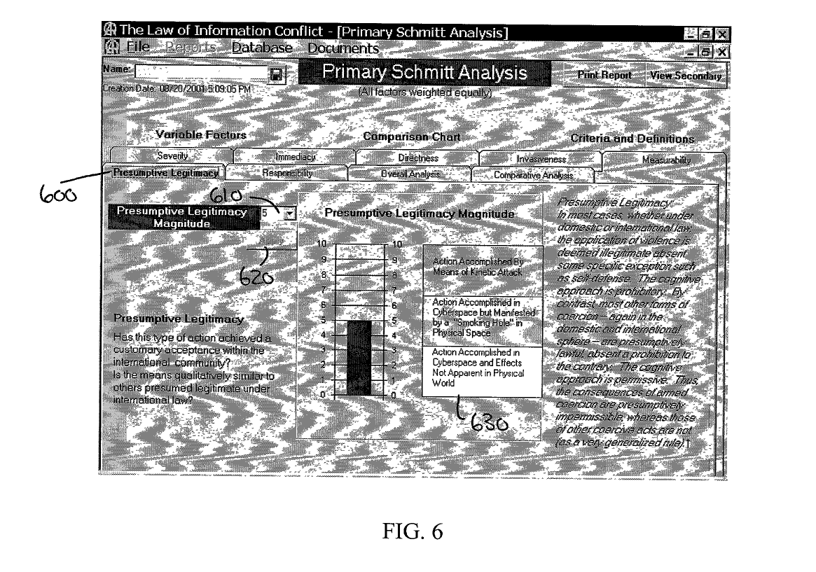

FIG. 6 illustrates an embodiment of the present invention used for determining the Presumptive Legitimacy Magnitude. In order to determine the Presumptive Legitimacy Magnitude, the Primary Schmitt Analysis poses two factual questions:

Has this type of action achieved a customary acceptance within the international community?

Is the means qualitatively similar to others presumed legitimate under international law?

In this scenario, the answers to these questions determine the presumed legitimacy of the Computer Network Attack.

In one embodiment, the Presumptive Legitimacy magnitude ranges from zero to about 3 for an action accomplished in cyberspace and effects not apparent in physical world; from about 4 to about 6 for an action accomplished in cyberspace but manifested by a “smoking hole” in physical space; and from about 7 to about 10 for an action accomplished by means of kinetic attack. Alternatively, the Presumptive Legitimacy magnitude of the three definitional ranges can be from zero to 3.33, from 3.34 to 6.66, and from 6.67 to 10, respectively. As would be apparent to one skilled in the art, other Presumptive Legitimacy magnitudes can be selected for each definitional range.

Information warfare is so new that a body of international law governing its use is not yet fully developed. Customary state practice defines much of international law. The necessity of such attacks will be a function of the necessity and proportionality of their implementation. As a result, it is determined that the Presumptive Legitimacy Magnitude should be quantified as a 5 on a scale of 1 to 10. The value 5 for the Presumptive Legitimacy Magnitude is calibrated to Definitions 630 and shows that the Computer Network Attack was accomplished in cyberspace but is manifested by an equivalent “smoking hole” in cyberspace.

In order to enter this quantification into the invention, Presumptive Legitimacy tab 600 is selected. The Presumptive Legitimacy Magnitude chosen can then be inputted into Entry 610. In embodiments, the magnitude for each Schmitt factor can be inputted as a fraction or with decimal places, 5.5 for example. Apply button 620 is then selected to submit the entry.

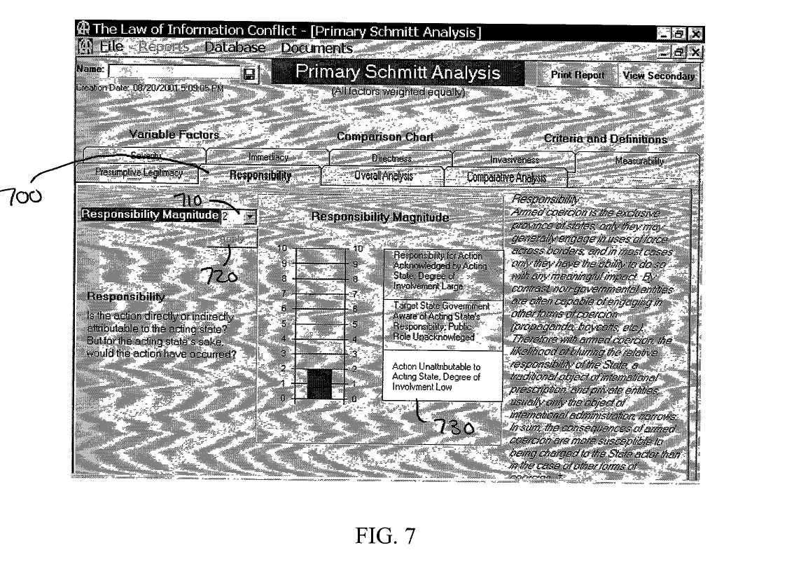

FIG. 7 illustrates an embodiment of the present invention used for determining the Responsibility Magnitude. In order to determine the Responsibility Magnitude, the Primary Schmitt Analysis poses two factual questions:

Is the action directly or indirectly attributable to the acting state?

But for the acting state's sake, would the action have occurred?

In this scenario, the answers to these questions determine the responsibility of the Computer Network Attack.

In one embodiment, the Responsibility magnitude ranges from zero to about 3 for action unattributable to acting state, degree of involvement low; from about 4 to about 6 for target state government aware of acting state's responsibility, public role unacknowledged; and from about 7 to about 10 for responsibility for action acknowledged by acting state, degree of involvement large. Alternatively, the Responsibility magnitude of the three definitional ranges can be from zero to 3.33, from 3.34 to 6.66, and from 6.67 to 10, respectively. As would be apparent to one skilled in the art, other Responsibility magnitudes can be selected for each definitional range.

The inability to determine who launched the Computer Network Attack is one of its greatest dangers from a defensive perspective, and one of its greatest offensive strengths. As the ability to trace attacks become more sophisticated, this option may become less advantageous in terms of the responsibility factor. As a result, it is determined that the Responsibility Magnitude should be quantified as a 2 on a scale of 1 to 10. The value 2 for the Responsibility Magnitude is calibrated to Definitions 730 and shows that the Computer Network Attack is not attributable to the U.S. and the degree of U.S. involvement is considered to be low.

In order to enter this quantification into the invention, Responsibility tab 700 is selected. The Responsibility Magnitude chosen can then be inputted into Entry 710. In embodiments, the magnitude for each Schmitt factor can be inputted as a fraction or with decimal places, 2.3 for example. Apply button 720 is then selected to submit the entry.

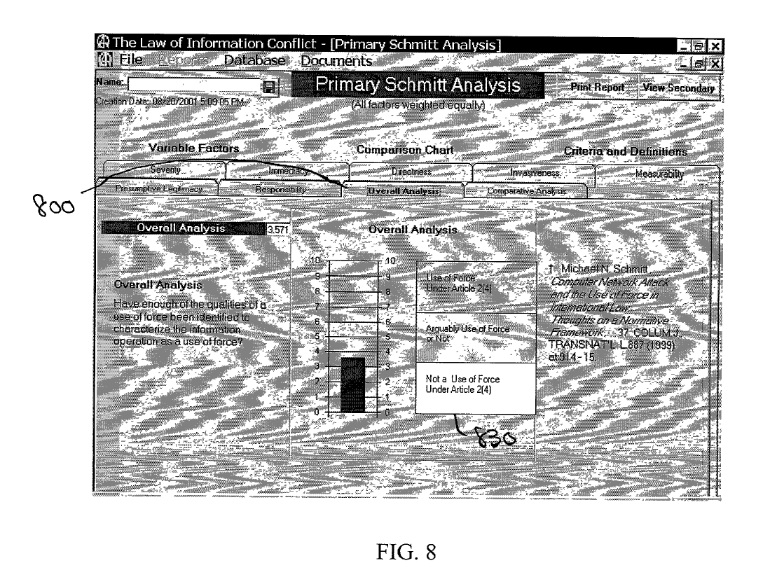

The primary objective of analyzing the scenario is to determine whether sufficient amounts of the qualities characteristic of a use of force have been identified to decide that the hypothetical Computer Network Attack will be a use of force. FIG. 8 illustrates an embodiment of the present invention that summarizes the results of a Primary Schmitt Analysis. By choosing Overall Analysis tab 800, the invention shows that the value of the Overall Analysis is 3.571. In one embodiment, the value of the Overall Analysis is the arithmetic average of the values previously entered for the seven individual Schmitt factors. For example, in this hypothetical, the arithmetic average of the value previously entered for the seven individual Schmitt factors is:

$$\frac{( 3 + 4 + 4 + 2 + 5 + 5 + 2 )}{7} = 3.571$$

This average is calibrated on Vertical Scale 830 to show that the Computer Network Attack is arguably a use of force under Article 2(4) of the U.N. Charter.

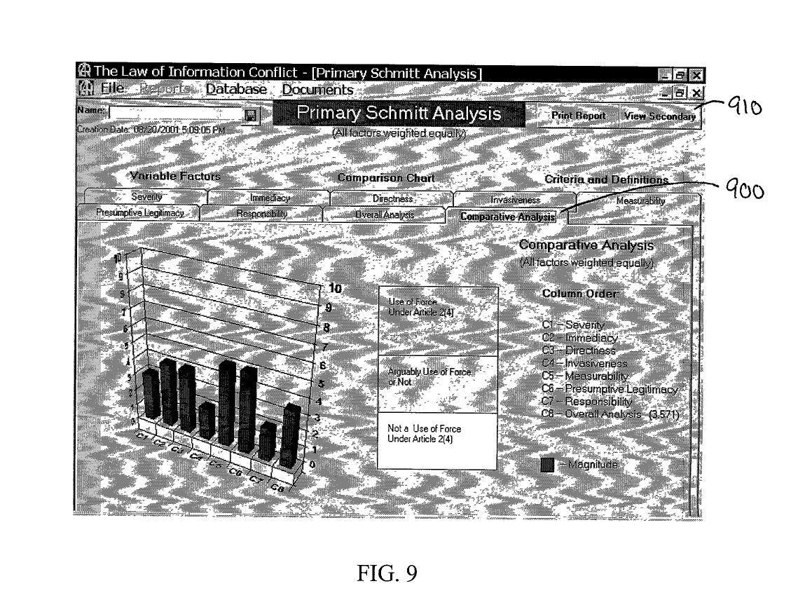

FIG. 9 illustrates an embodiment of the present invention that displays a summary of the values previously entered for the seven individual Schmitt factors as well as the computed Overall Analysis. This can be viewed by selecting Comparative Analysis tab 900.

In embodiments, the invention also provides for a Secondary Schmitt Analysis, which allows the various Schmitt factors to be weighted individually in cases where a factor may, for example, be two or three times more important to the user. In a Primary Schmitt Analysis, each factor is weighted equally.

In the illustrations above, choosing a magnitude for each Schmitt factor consisted of making a factual determination of the action and surrounding circumstances. For a Secondary Schmitt Analysis, a legal judgment is needed to determine the weight assigned to each Schmitt factor given the context of the situation. In embodiments, attorneys are consulted during the process of assigning weights to the Schmitt factors.

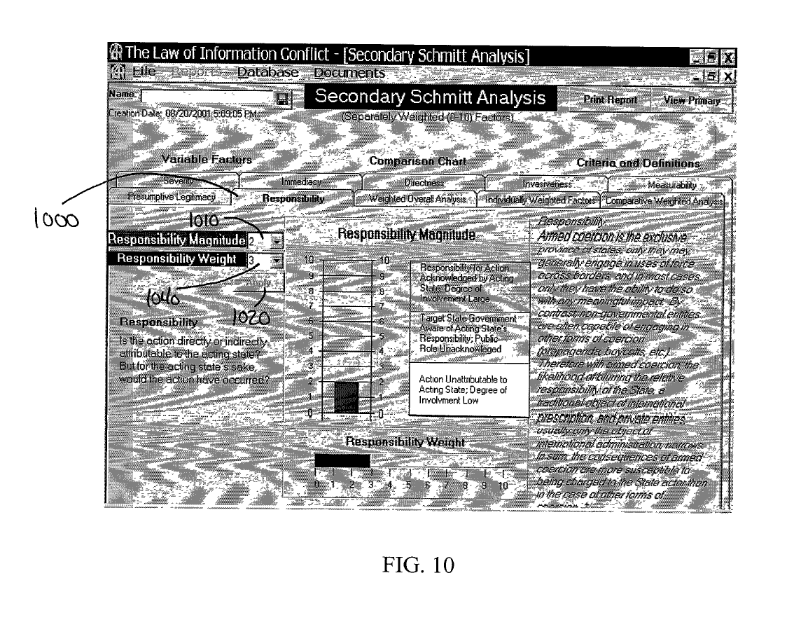

In the illustration above, assume that the user decides that the Responsibility factor should be considered three times as important as any other factor. FIG. 10 illustrates an embodiment of the present invention wherein the user can perform a Secondary Schmitt Analysis by selecting a Responsibility Weight for the Responsibility Magnitude. The user would first select the View Secondary button 910 in the upper right hand comer of FIG. 9, or in any Primary Schmitt Analysis screen. The user would then select Responsibility tab 1000 on FIG. 10. FIG. 10 resembles FIG. 7 with the addition of Entry 1040 for weighting the Responsibility factor and a graph for displaying that weight. The user may also adjust the Responsibility Magnitude in Entry 1010 on this screen. There are corresponding Secondary Schmitt Analysis screens for each of the other six Schmitt factors so that individual weightings can be assigned to each factor. In embodiments of the invention, a user can perform a Primary and a Secondary Schmitt Analysis at the same time.

In order to adjust the Responsibility Weight to 3, the desired weight can be inputted into Entry 1040. In embodiments, the desired weight can be inputted as a fraction or with decimal places, 3.5 for example. Apply button 1020 is then selected to submit the entry.

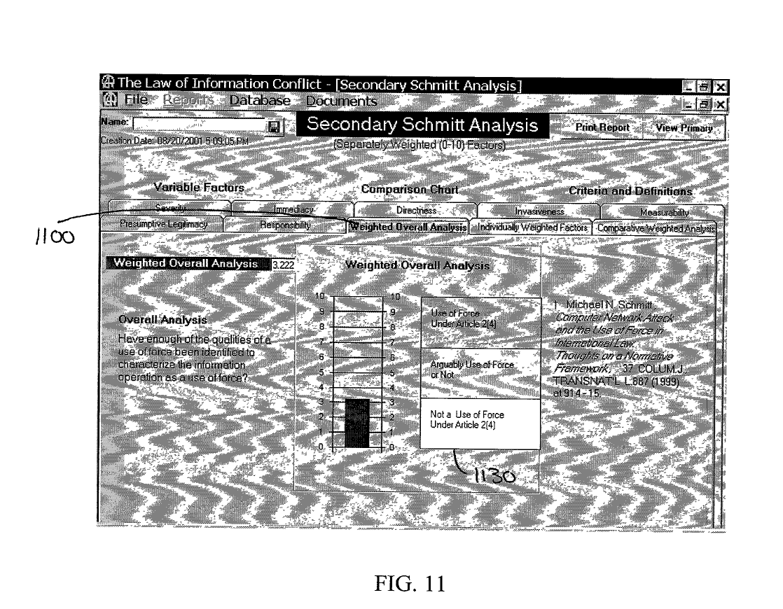

FIG. 11 illustrates an embodiment of the present invention that summarizes the results of a Secondary Schmitt Analysis. By choosing Weighted Overall Analysis tab 1100, the invention shows that the value of the Weighted Overall Analysis is now 3.222. In an embodiment of the invention, the value of the Weighted Overall Analysis is a weighted average of the values previously entered for the seven individual Schmitt factors. In an embodiment, the weighted average is calculated by dividing the sum of the seven Schmitt factor magnitudes multiplied by their individual factor weights by the sum of the individual factor weights. For example, in this illustration, the value of the Weighted Overall Analysis is calculated as follows:

$$\frac{( 3 \times 1 ) + ( 4 \times 1 ) + ( 4 \times 1 ) + ( 2 \times 1 ) + ( 5 \times 1 ) + ( 5 \times 1 ) + ( 2 \times 3 )}{( 1 + 1 + 1 + 1 + 1 + 1 + 3 )} = 3.222$$

Again, the primary objective of analyzing the scenario is to determine whether sufficient amounts of the qualities characteristic of a use of force have been identified to decide that the Computer Network Attack is a use of force. The value of the Weighted Overall Analysis in this example is 3.222. This weighted average is calibrated on Vertical Scale 1130 to show that the Computer Network Attack is arguably a use of force under Article 2(4) of the U.N. Charter. Since Computer Network Attack is, by its nature, a provocative action, it becomes more desirable when it is not attributable to the true attacker, even with an overweighted Responsibility factor, as in this illustration.

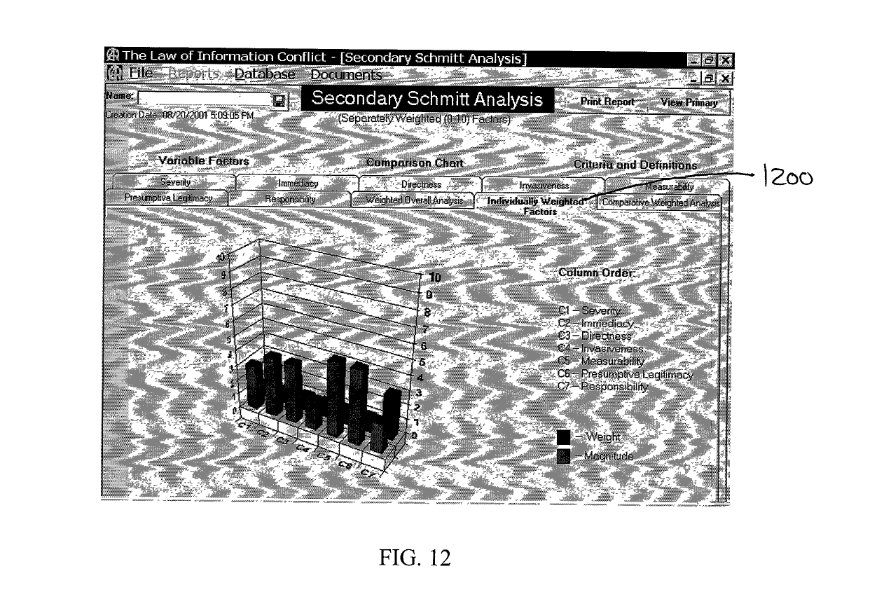

FIG. 12 illustrates an embodiment of the present invention that displays a summary of the values previously entered for the seven individual Schmitt factors and their respective weightings. This can be viewed by selecting Individually Weighted Factors tab 1200.

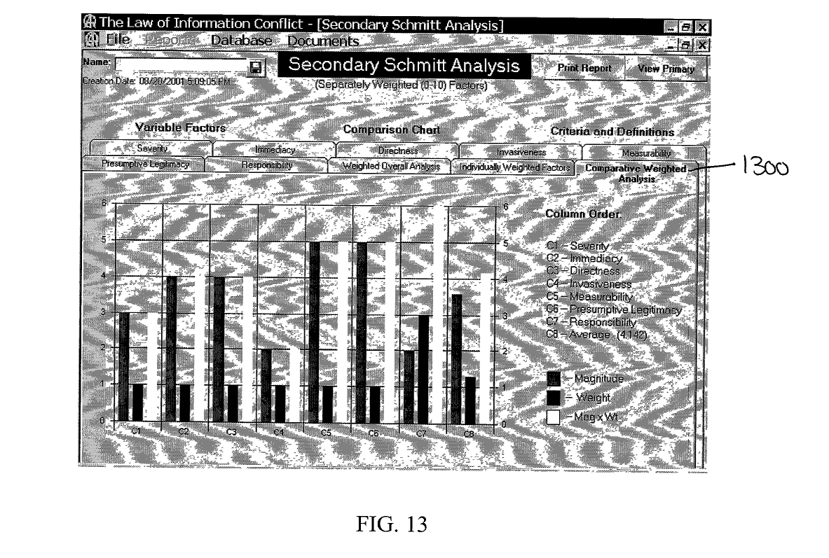

FIG. 13 illustrates an embodiment of the present invention that displays the values assigned to each Schmitt factor for both magnitude and weight as well as the magnitude multiplied by the weight. This shows how the weights assigned to the factors can significantly change the results. This can be viewed by selecting Comparative Weighted Analysis tab 1300.

In embodiments of the invention, the analysis of each scenario can be printed and saved on a computer readable medium. Different analyses can then be compared and contrasted.

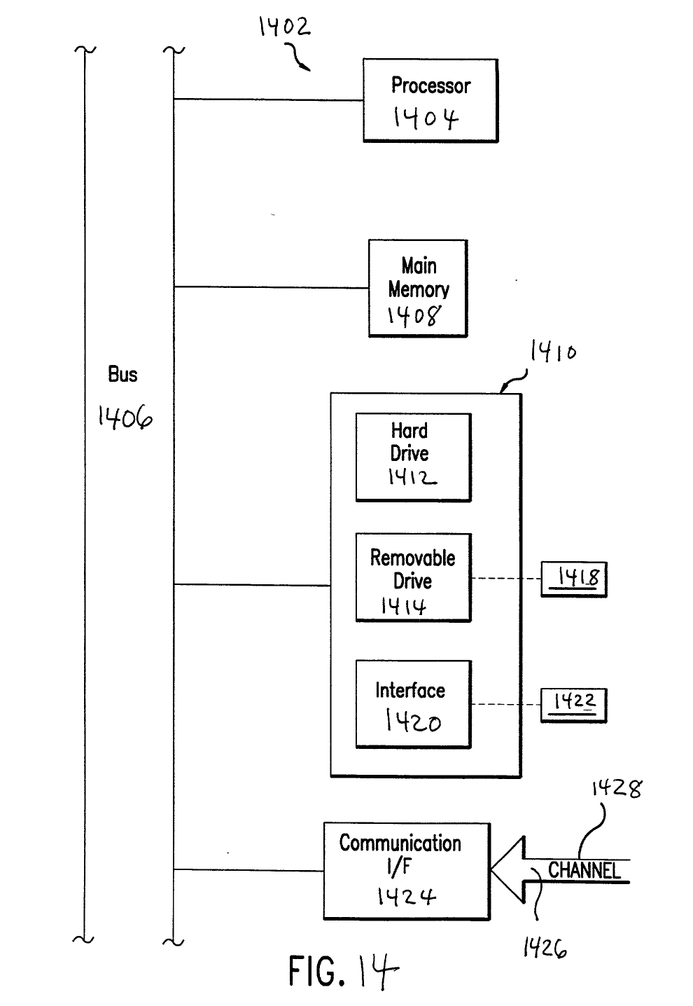

A computer system capable of carrying out the functionality described herein is shown in FIG. 14. Computer system 1402 includes one or more processors, such as processor 1404. Processor 1404 is connected to a communication bus 1406. Various software embodiments are described in terms of this exemplary computer system. After reading this description, it will become apparent to a person skilled in the relevant art how to implement the invention using other computer systems and/or computer architectures.

Computer system 1402 also includes a main memory 1408, preferably random access memory (RAM), and can also include a secondary memory 1410. Secondary memory 1410 can include, for example, a hard disk drive 1412 and/or a removable storage drive 1414, representing a floppy disk drive, a magnetic tape drive, an optical disk drive, etc. Removable storage drive 1414 reads from and/or writes to a removable storage unit 1418 in a well known manner. Removable storage unit 1418, represents a floppy disk, magnetic tape, optical disk, etc. which is read by and written to by removable storage drive 1414. As will be appreciated, removable storage unit 1418 includes a computer usable storage medium having stored therein computer software and/or data.

In alternative embodiments, secondary memory 1410 may include other similar means for allowing computer programs or other instructions to be loaded into computer system 1402. Such means can include, for example, a removable storage unit 1422 and an interface 1420. Examples of such can include a program cartridge and cartridge interface (such as that found in video game devices), a removable memory chip (such as an EPROM, or PROM) and associated socket, and other removable storage units 1422 and interfaces 1420 which allow software and data to be transferred from removable storage unit 1422 to computer system 1402.

Computer system 1402 can also include a communications interface 1424. Communications interface 1424 allows software and data to be transferred between computer system 1402 and external devices. Examples of communications interface 1424 can include a modem, a network interface (such as an Ethernet card), a communications port, a PCMCIA slot and card, etc. Software and data transferred via communications interface 1424 are in the form of signals 1426 that can be electronic, electromagnetic, optical or other signals capable of being received by communications interface 1424. Signals 1426 are provided to communications interface via a channel 1428. Channel 1428 carries signals 1426 and can be implemented using wire or cable, fiber optics, a phone line, a cellular phone link, an RF link and other communications channels.

In this document, the terms “computer program medium” and “computer usable medium” are used to generally refer to media such as removable storage device 1418, a hard disk installed in hard disk drive 1412, and signals 1426. These computer program products are means for providing software to computer system 1402.

Computer programs (also called computer control logic) are stored in main memory 1408 and/or secondary memory 1410. Computer programs can also be received via communications interface 1424. Such computer programs, when executed, enable computer system 1402 to perform the features of the present invention as discussed herein. In particular, the computer programs, when executed, enable processor 1404 to perform the features of the present invention. Accordingly, such computer programs represent controllers of computer system 1402.

In an embodiment where the invention is implemented using software, the software may be stored in a computer program product and loaded into computer system 1402 using removable storage drive 1414, hard drive 1412 or communications interface 1424. The control logic (software), when executed by processor 1404, causes processor 1404 to perform the functions of the invention as described herein.

Computer system 1402 can be configured as an analysis system to carry out the functionality of the present invention. Computer system 1402 can be further configured to include a display for displaying the results of the analysis.

In another embodiment, the invention is implemented primarily in hardware using, for example, hardware components such as application specific integrated circuits (ASICs). Implementation of such a hardware state machine so as to perform the functions described herein will be apparent to persons skilled in the relevant art(s).

In yet another embodiment, the invention is implemented using a combination of both hardware and software.

While there have been shown and described specific embodiments of the present invention, it should be apparent to those skilled in the art that various changes and modifications may be made without departing from the scope of the invention or its equivalents. The invention is intended to be broadly protected consistent with the spirit and scope of the appended claims.

What is claimed is:

1. A method of evaluating actions under international law comprising:
identifying an action and the action's effects; and
performing a Primary Schmitt analysis comprising
determining the action's Severity,
determining the action's Immediacy,
determining the action's Directness,
determining the action's Invasiveness,
determining the action's Measurability,
determining the action's Presumptive Legitimacy, and
determining Responsibility for the action.

2. The method of claim 1, further comprising:
assigning a numerical Severity magnitude in response to determining the action's Severity;
assigning a numerical Immediacy magnitude in response to determining the action's Immediacy;
assigning a numerical Directness magnitude in response to determining the action's Directness;
assigning a numerical Invasiveness magnitude in response to determining the action's Invasiveness;
assigning a numerical Measurability magnitude in response to determining the action's Measurability;
assigning a numerical Presumptive Legitimacy magnitude in response to determining the action's Presumptive Legitimacy; and
assigning a numerical Responsibility magnitude in response to determining Responsibility for the action.

3. The method of claim 1 wherein determining the action's Severity comprises:
ascertaining how many people were killed;
ascertaining how large an area was affected;
ascertaining how much damage was done within the area; and
assigning a Severity magnitude responsive to the ascertaining steps.

4. The method of claim 3 wherein
the Severity magnitude is within the range of zero to about 3 if people are unaffected or there is no discernable property damage,
the Severity magnitude is within the range of about 4 to about 6 if people are injured or there is moderate property damage, and
the Severity magnitude is within the range of about 7 to about 10 if people are killed or there is severe property damage.

5. The method of claim 1 wherein determining the action's Immediacy comprises:
ascertaining a duration of the action;
ascertaining how soon the effect is felt;
ascertaining how soon the effect abates; and
assigning an Immediacy magnitude responsive to the ascertaining steps.

6. The method of claim 5 wherein
the Immediacy magnitude is within the range of zero to about 3 if the effect lasts less than an hour,
the Immediacy magnitude is within the range of about 4 to about 6 if the effect lasts a few hours or days, and
the Immediacy magnitude is within the range of about 7 to about 10 if the effect lasts a few weeks or longer.

7. The method of claim 1 wherein determining the action's Directness comprises:
ascertaining whether the action can be distinguished from parallel or competing actions;
ascertaining whether the action was a cause of the effect; and
assigning a Directness magnitude responsive to the ascertaining steps.

8. The method of claim 7 wherein
the Directness magnitude is within the range of zero to about 3 if the action did not cause any part of the effect,
the Directness magnitude is within the range of about 4 to about 6 if the action is one cause of the effect, and
the Directness magnitude is within the range of about 7 to about 10 if the action is the sole cause of the effect.

9. The method of claim 1 wherein determining the action's Invasiveness comprises:
ascertaining whether the action involved physically crossing a target country's border;
ascertaining whether the action's locus was within the target country; and
assigning an Invasiveness magnitude responsive to the ascertaining steps.

10. The method of claim 9 wherein
the Invasiveness magnitude is within the range of zero to about 3 if the action did not consist of crossing the target country's border or the action has no identifiable locus within the target country,
the Invasiveness magnitude is within the range of about 4 to about 6 if the action consisted of electronically crossing the target country's border or the action's locus was diffuse, and
the Invasiveness magnitude is within the range of about 7 to about 10 if the action consisted of physically crossing the target country's border and the action's locus was within the target country.

11. The method of claim 1 wherein determining the action's Measurability comprises:
ascertaining whether the effect can be quantified;
ascertaining whether the effect is distinct from the results of parallel or competing actions;
ascertaining a level of certainty of the effect; and
assigning a Measurability magnitude responsive to the ascertaining steps.

12. The method of claim 11 wherein
the Measurability magnitude is within the range of zero to about 3 if the effect cannot be separated from parallel or competing actions or the certainty is low,
the Measurability magnitude is within the range of about 4 to about 6 if the effect can be estimated with moderate certainty, and
the Measurability magnitude is within the range of about 7 to about 10 if the effect can be quantified immediately with high certainty.

13. The method of claim 1 wherein determining the action's Presumptive Legitimacy comprises:
ascertaining whether the action is customarily accepted within the international community;
ascertaining whether the action's means are qualitatively similar to those presumed legitimate under international law; and
assigning a Presumptive Legitimacy magnitude responsive to the ascertaining steps.

14. The method of claim 13 wherein
the Presumptive Legitimacy magnitude is within the range of zero to about 3 if the action is accomplished electronically and the effect is not apparent in the physical world,
the Presumptive Legitimacy magnitude is within the range of about 4 to about 6 if the action is accomplished electronically and the effect is apparent in the physical world, and
the Presumptive Legitimacy magnitude is within the range of about 7 to about 10 if the action is accomplished by physical means.

15. The method of claim 1 wherein determining Responsibility for the action comprises:
ascertaining whether the action is directly attributable to an actor;
ascertaining whether the action is indirectly attributable to the actor; and
assigning a Responsibility magnitude responsive to the ascertaining steps.

16. The method of claim 15 wherein
the Responsibility magnitude is within the range of zero to about 3 if the action can not be attributable to the actor or the actor's involvement is low,
the Responsibility magnitude is within the range of about 4 to about 6 if a target country has knowledge of the actor's involvement but the actor does not acknowledge responsibility for the action, and
the Responsibility magnitude is within the range of about 7 to about 10 if the actor acknowledges responsibility for the action and the actor's involvement is high.

17. The method of claim 2, further comprising:
calculating an arithmetic average of the Severity magnitude, the Immediacy magnitude, the Directness magnitude, the Invasiveness magnitude, the Measurability magnitude, the Presumptive Legitimacy magnitude, and the Responsibility magnitude.

18. The method of claim 17, further comprising:
displaying the arithmetic average, the Severity magnitude, the Immediacy magnitude, the Directness magnitude, the Invasiveness magnitude, the Measurability magnitude, the Presumptive Legitimacy magnitude, and the Responsibility magnitude.

19. The method of claim 18 wherein displaying comprises:
displaying each of the arithmetic average, the Severity magnitude, the Immediacy magnitude, the Directness magnitude, the Invasiveness magnitude, the Measurability magnitude, the Presumptive Legitimacy magnitude, and the Responsibility magnitude on a scale from zero to ten.

20. The method of claim 18 wherein displaying comprises:
displaying each of the arithmetic average, the Severity magnitude, the Immediacy magnitude, the Directness magnitude, the Invasiveness magnitude, the Measurability magnitude, the Presumptive Legitimacy magnitude, and the Responsibility magnitude on a bar graph.

21. The method of claim 17, further comprising:
determining responsive to the arithmetic average whether the action is a use of force according to United Nations Charter Article 2(4).

22. The method of claim 17, further comprising:
reevaluating the action's Severity;
reevaluating the action's Immediacy;
reevaluating the action's Directness;
reevaluating the action's Invasiveness;
reevaluating the action's Measurability;
reevaluating the action's Presumptive Legitimacy; and
reevaluating Responsibility for the action.

23. The method of claim 22, further comprising:
assigning a revised Severity magnitude in response to reevaluating the action's Severity; and
recalculating an arithmetic average of the revised Severity magnitude, the Immediacy magnitude, the Directness magnitude, the Invasiveness magnitude, the Measurability magnitude, the Presumptive Legitimacy magnitude, and the Responsibility magnitude.

24. The method of claim 22, further comprising:
assigning a revised Immediacy magnitude in response to reevaluating the action's Immediacy; and
recalculating an arithmetic average of the Severity magnitude, the revised Immediacy magnitude, the Directness magnitude, the Invasiveness magnitude, the Measurability magnitude, the Presumptive Legitimacy magnitude, and the Responsibility magnitude.

25. The method of claim 22, further comprising:
assigning a revised Directness magnitude in response to reevaluating the action's Directness; and
recalculating an arithmetic average of the Severity magnitude, the Immediacy magnitude, the revised Directness magnitude, the Invasiveness magnitude, the Measurability magnitude, the Presumptive Legitimacy magnitude, and the Responsibility magnitude.

26. The method of claim 22, further comprising:
assigning a revised Invasiveness magnitude in response to reevaluating the action's Invasiveness; and
recalculating an arithmetic average of the Severity magnitude, the Immediacy magnitude, the Directness magnitude, the revised Invasiveness magnitude, the Measurability magnitude, the Presumptive Legitimacy magnitude, and the Responsibility magnitude.

27. The method of claim 22, further comprising:
assigning a revised Measurability magnitude in response to reevaluating the action's Measurability; and
recalculating an arithmetic average of the Severity magnitude, the Immediacy magnitude, the Directness magnitude, the Invasiveness magnitude, the revised Measurability magnitude, the Presumptive Legitimacy magnitude, and the Responsibility magnitude.

28. The method of claim 22, further comprising:
assigning a revised Presumptive Legitimacy magnitude in response to reevaluating the action's Presumptive Legitimacy; and
recalculating an arithmetic average of the Severity magnitude, the Immediacy magnitude, the Directness magnitude, the Invasiveness magnitude, the Measurability magnitude, the revised Presumptive Legitimacy magnitude, and the Responsibility magnitude.

29. The method of claim 22, further comprising:
assigning a revised Responsibility magnitude in response to reevaluating the Responsibility for the action; and
recalculating an arithmetic average of the Severity magnitude, the Immediacy magnitude, the Directness magnitude, the Invasiveness magnitude, the Measurability magnitude, the Presumptive Legitimacy magnitude, and the revised Responsibility magnitude.

30. The method of claim 2 further comprising the step of:
performing a Secondary Schmitt analysis.

31. The method of claim 30 wherein performing a Secondary Schmitt analysis comprises:
assigning a legal weight to each of
the Severity magnitude,
the Immediacy magnitude,
the Directness magnitude,
the Invasiveness magnitude,
the Measurability magnitude,
the Presumptive Legitimacy magnitude, and
the Responsibility magnitude; and
multiplying
the Severity magnitude by its legal weight to produce a Severity result,
the Immediacy magnitude by its legal weight to produce an Immediacy result,
the Directness magnitude by its legal weight to produce a Directness result,
the Invasiveness magnitude by its legal weight to produce an Invasiveness result,
the Measurability magnitude by its legal weight to produce a Measurability result,
the Presumptive Legitimacy magnitude by its legal weight to produce a Presumptive Legitimacy result, and
the Responsibility magnitude by its legal weight to produce a Responsibility result.

32. The method of claim 31 wherein the legal weights are values from zero to ten.

33. The method of claim 31 further comprising:
adding the Severity result, the Immediacy result, the Directness result, the Invasiveness result, the Measurability result, the Presumptive Legitimacy result, and the Responsibility result to produce an aggregate sum, and
dividing the aggregate sum by a sum of the legal weight of the Severity magnitude, the legal weight of the Immediacy magnitude, the legal weight of the Directness magnitude, the legal weight of the Invasiveness magnitude, the legal weight of the Measurability magnitude, the legal weight of the Presumptive Legitimacy magnitude, the legal weight of the Responsibility magnitude to calculate a weighted magnitude.

34. The method of claim 31, further comprising:
displaying
the Severity magnitude and its legal weight,
the Immediacy magnitude and its legal weight,
the Directness magnitude and its legal weight,
the Invasiveness magnitude and its legal weight,
the Measurability magnitude and its legal weight,
the Presumptive Legitimacy magnitude and its legal weight, and
the Responsibility magnitude and its legal weight.

35. The method of claim 33, further comprising:
displaying the weighted magnitude.

36. The method of claim 33, further comprising:
determining responsive to the weighted magnitude whether the action is a use of force according to United Nations Charter Article 2(4).

37. The method of claim 30, further comprising:
identifying a second action and the second action's effect;
performing a second Primary Schmitt analysis;
performing a second Secondary Schmitt analysis
comparing results of the two Secondary Schmitt analyses.

38. A computer program product comprising a computer usable medium having computer program logic recorded thereon for enabling a processor in a computer system to facilitate performing Primary and Secondary Schmitt analyses, said computer program logic comprising:
storage means for enabling the processor to store a Severity magnitude, an Immediacy magnitude, a Directness magnitude, an Invasiveness magnitude, a Measurability magnitude, a Presumptive Legitimacy magnitude, a Responsibility magnitude, and each of their legal weights; and
calculating means for calculating
an arithmetic average of the Severity magnitude, the Immediacy magnitude, the Directness magnitude, the Invasiveness magnitude, the Measurability magnitude, the Presumptive Legitimacy magnitude, and the Responsibility magnitude,
a product of the Severity magnitude and its legal weight to produce a Severity result,
a product of the Immediacy magnitude and its legal weight to produce an Immediacy result,
a product of the Directness magnitude and its legal weight to produce a Directness result,
a product of the Invasiveness magnitude and its legal weight to produce an Invasiveness result,
a product of the Measurability magnitude and its legal weight to produce a Measurability result,
a product of the Presumptive Legitimacy magnitude and its legal weight to produce a Presumptive Legitimacy result,
a product of the Responsibility magnitude and its legal weight to produce a Responsibility result,
a sum of the Severity result, the Immediacy result, the Directness result, the Invasiveness result, the Measurability result, the Presumptive Legitimacy result, and the Responsibility result to produce an aggregate sum, and
a quotient of the aggregate sum divided by a sum of the legal weight of the Severity magnitude, the legal weight of the Immediacy magnitude, the legal weight of the Directness magnitude, the legal weight of the Invasiveness magnitude, the legal weight of the Measurability magnitude, the legal weight of the Presumptive Legitimacy magnitude, the legal weight of the Responsibility magnitude to produce a weighted magnitude.

39. An analysis system comprising:
a data processing apparatus, and
input means for inputting instructions to said apparatus to perform a Schmitt analysis responsive to
a selected Severity magnitude and its selected legal weight,
a selected Immediacy magnitude and its selected legal weight,
a selected Directness magnitude and its selected legal weight,
a selected Invasiveness magnitude and its selected legal weight,
a selected Measurability magnitude and its selected legal weight,
a selected Presumptive Legitimacy magnitude and its selected legal weight, and
a selected Responsibility magnitude and its selected legal weight.

40. The system of claim 30 further comprising:
means for storing and retrieving
the selected Severity magnitude and its selected legal weight,
the selected Immediacy magnitude and its selected legal weight,
the selected Directness magnitude and its selected legal weight,
the selected Invasiveness magnitude and its selected legal weight,
the selected Measurability magnitude and its selected legal weight,
the selected Presumptive Legitimacy magnitude and its selected legal weight, and
the selected Responsibility magnitude and its selected legal weight.

41. The system of claim 39 further comprising:
means for displaying
the selected Severity magnitude and its selected legal weight,
the selected Immediacy magnitude and its selected legal weight,
the selected Directness magnitude and its selected legal weight,
the selected Invasiveness magnitude and its selected legal weight,
the selected Measurability magnitude and its selected legal weight,
the selected Presumptive Legitimacy magnitude and its selected legal weight, and
the selected Responsibility magnitude and its selected legal weight.
